(19) United States
(12) Patent Application Publication
(10) Pub. No.: US 2026/0004806 A1
(43) Pub. Date: Jan. 1, 2026

(54) LOW CROSSTALK PIGGY-BACK TAPE HEAD

(71) Applicant: International Business Machines Corporation, Armonk, NY (US)

(72) Inventors: Mark Alfred Lantz, Adliswil (CH); Hugo E. Rothuizen, OBERRIEDEN (CH); Simeon Furrer, Altdorf (CH); Beat Eugen Weiss, Edlibach (CH); Luzius Kronig, Zürich (CH); Stella Brach, Zurich (CH)

(21) Appl. No.: 18/758,384

(22) Filed: Jun. 28, 2024

(51) Int. Cl. G11B 5/31; G11B 5/48

(52) U.S. Cl. CPC G11B 5/3163; G11B 5/3116; G11B 5/4826; G11B 5/486

(57) ABSTRACT

A write chip comprising an array of write transducers and writer bond pads is obtained, each write transducer of the array of write transducers connected to a pair of bond pads of the writer bond pads via electrically conducting signal wires, the write chip comprising a write notch. A read chip comprising an array of read transducers and reader bond pads is obtained, each read transducer of the array of read transducers connected to a pair of bond pads of the reader bond pads via electrically conducting signal wires, the read chip comprising a read notch. The read chip and the write chip are secured together such that a distance between the write transducer array and the read transducer array is less than 100 microns, an orientation of the write notch exposes the reader bond pads, and an orientation of the read notch exposes the writer bond pads.

### BACKGROUND

The present invention relates generally to the electrical, electronic and computer arts and, more particularly, to electronic storage systems.

Track density scaling is currently a main driver of tape capacity scaling and is expected to remain so for the foreseeable future. Tape dimensional stability (TDS) is one of the main challenges inhibiting track density scaling. Compensating for TDS becomes increasingly important with each new generation of tape drive that is expected to operate with an increasingly reduced track pitch.

### BRIEF SUMMARY

Principles of the invention provide systems and techniques for low crosstalk piggy-back tape head. In one aspect, an exemplary method includes the operations of fabricating a tape head comprising obtaining a write chip comprising an array of write transducers and writer bond pads, each write transducer of the array of write transducers connected to a pair of bond pads of the writer bond pads via electrically conducting signal wires, the write chip comprising a write notch; obtaining a read chip comprising an array of read transducers and reader bond pads, each read transducer of the array of read transducers connected to a pair of bond pads of the reader bond pads via electrically conducting signal wires, the read chip comprising a read notch; and securing the read chip and the write chip together such that a distance between the write transducer array and the read transducer array is less than 100 microns, an orientation of the write notch exposes the reader bond pads, and an orientation of the read notch exposes the writer bond pads.

In one aspect, a tape head comprises a write chip, the write chip comprising an array of write transducers and writer bond pads, and comprising a write notch; and a read chip, the read chip comprising an array of read transducers and reader bond pads, and comprising a read notch; wherein the read chip and the write chip are secured together such that a distance between the write transducer array and the read transducer array is less than 100 microns, an orientation of the write notch exposes the reader bond pads, and an orientation of the read notch exposes the writer bond pads.

In one aspect, a tape drive comprises a tape drive electronics and mechanics module; a write chip coupled to the tape drive electronics and mechanics module, the write chip comprising an array of write transducers and writer bond pads, and comprising a write notch; and a read chip coupled to the tape drive electronics and mechanics module, the read chip comprising an array of read transducers and reader bond pads, and comprising a read notch; wherein the read chip and the write chip are secured together such that a distance between the write transducer array and the read transducer array is less than 100 microns, an orientation of the write notch exposes the reader bond pads, and an orientation of the read notch exposes the writer bond pads.

In one aspect, a method comprises writing data on a tape using a write chip, the write chip comprising an array of write transducers and writer bond pads, and comprising a write notch; and reading the data on the tape using a read chip, the read chip comprising an array of read transducers and reader bond pads, and comprising a read notch; wherein the read chip and the write chip are secured together such that a distance between the write transducer array and the read transducer array is less than 100 microns.

In one aspect, a computer program product, comprises one or more tangible computer-readable storage media and program instructions stored on at least one of the one or more tangible computer-readable storage media, the program instructions executable by a processor, the program instructions comprising writing data on a tape using a write chip, the write chip comprising an array of write transducers and writer bond pads, and comprising a write notch; and reading the data on the tape using a read chip, the read chip comprising an array of read transducers and reader bond pads, and comprising a read notch; wherein the read chip and the write chip are secured together such that a distance between the write transducer array and the read transducer array is less than 100 microns.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, tape head/tape drive fabrication equipment, or the like by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates a high-level view of a conventional tape head while writing and verifying data;

FIG. 1B illustrates a top view of a write chip and a read chip of a two-module head (write and read) for a tape drive, in accordance with an example embodiment;

FIG. 1C illustrates a top view of the write chip and a bottom view of the read chip of a two-module head for a tape drive, in accordance with an example embodiment;

FIG. 1D illustrates a top view of the write chip secured to the read chip of a two-module head for a tape drive, in accordance with an example embodiment;

FIG. 1E illustrates a side view of the tape bearing surface (TBS) of the two-module head of FIG. 1D formed of the write chip secured to the read chip, in accordance with an example embodiment;

FIG. 1F illustrates a top view of a mini closure prior to securing to the write chip and the read chip of a two-module head (write and read) for a tape drive, in accordance with an example embodiment;

FIG. 1G illustrates a top view of the mini closure after securing to the write chip, in accordance with an example embodiment;

FIG. 1H illustrates a top view of the write chip secured to the read chip of a two-module head for a tape drive with the mini closure residing between the write chip and the read chip, in accordance with an example embodiment;

FIG. 1I illustrates a side view of the tape bearing surface (TBS) of the two-module head of FIG. 1H formed of the write chip secured to the read chip with the mini closure residing between the write chip and the read chip, in accordance with an example embodiment;

FIG. 1K illustrates a top view of a shielding layer after depositing on the write chip and a shielding layer after depositing on the read chip, in accordance with an example embodiment;

FIG. 1L illustrates a top view of the write chip with a shielding layer and a bottom view of the read chip with a shielding layer after vertically flipping, in accordance with an example embodiment;

FIG. 1M illustrates a top view of the write chip secured to the read chip of a two-module head for a tape drive with the shielding layer(s) residing between the write chip and the read chip, in accordance with an example embodiment;

FIG. 1N illustrates a side view of the tape bearing surface (TBS) of the two-module head of FIG. 1M formed of the write chip secured to the read chip with the shielding layers residing between the write chip and the read chip, in accordance with an example embodiment; and

FIG. 2 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that, in general terms, an exemplary method, according to an aspect of the invention, includes the operations of fabricating a tape head comprising obtaining a write chip 212 comprising an array of write transducers 216 and writer bond pads 236, each write transducer of the array of write transducers 216 connected to a pair of bond pads of the writer bond pads 236 via electrically conducting signal wires, the write chip 212 comprising a write notch 228; obtaining a read chip 220 comprising an array of read transducers 224 and reader bond pads 240, each read transducer of the array of read transducers 224 connected to a pair of bond pads of the reader bond pads 240 via electrically conducting signal wires, the read chip 220 comprising a read notch 232; and securing the read chip 220 and the write chip 212 together such that a distance between the write transducer array 216 and the read transducer array 224 is less than 100 microns, an orientation of the write notch 228 exposes the reader bond pads 240, and an orientation of the read notch 232 exposes the writer bond pads 236. The technical benefits include a tape writer with a width comparable to the target track pitch and providing an ˜10% capacity gain in comparison to conventional tape writer configurations.

The read chip 220 comprising a notch means that the outline of the read chip 220 defines a notch 228 and the write chip 212 comprising a notch means that the outline of the write chip 212 defines a notch 228.

In example embodiments, the obtaining the write chip comprises fabricating the write chip, and the fabricating of the write chip 212 includes forming the plurality of signal wires that fan out from the write transducer array 216 to the writer bond pads 236 toward one end of the write chip 212. The technical benefits include providing access to the writer bond pads 236 while providing a tape writer with a width comparable to the target track pitch and an ˜10% capacity gain in comparison to conventional tape writer configurations.

In example embodiments, the obtaining the read chip comprises fabricating the read chip, and the fabricating of the read chip 220 includes forming the plurality of signal wires that fan out from the read transducer array 224 to the reader bond pads 240 toward one end of the read chip 220. The technical benefits include providing access to the reader bond pads 240 while providing a tape writer with a width comparable to the target track pitch and an ˜10% capacity gain in comparison to conventional tape writer configurations.

In example embodiments, the obtaining the write chip comprises fabricating the write chip, and the fabricating of the write chip 212 includes fabricating a shield 286 above a plane containing the signal wires (e.g., above layers with signal wires) of the write chip 212. The technical benefits include reducing magnetic and or electrical cross talk between the write transducers and the read transducers.

In example embodiments, in the step of fabricating the shield 286, the shield 286 includes at least one of a magnetic shield and an electrical shield. The technical benefits include reducing magnetic and or electrical cross talk, as the case may be, between the write transducers and the read transducers.

In example embodiments, the obtaining the read chip comprises fabricating the read chip, and the fabricating of the read chip 220 includes fabricating a shield 290 above a plane containing the signal wires (e.g., above layers with signal wires) of the read chip 220. The technical benefits include reducing magnetic and or electrical cross talk between the write transducers and the read transducers.

In example embodiments, in the step of fabricating the shield 290, the shield 290 includes at least one of a magnetic shield and an electrical shield. The technical benefits include reducing magnetic and or electrical cross talk, as the case may be, between the write transducers and the read transducers.

In example embodiments, the obtaining the read chip comprises fabricating the read chip, and the fabricating of the read chip 220 includes fabricating a mini closure 282 on a surface of the read chip 220 to tune a distance between the array of read transducers 224 and the array of write transducers 216. The technical benefits include a short closure on one of the modules of the tape head (before assembly) for tuning the distance between tape writers and tape readers, and providing enhanced wear robustness (by reducing the span of tape not supported by a hard ceramic).

In example embodiments, the obtaining the write chip comprises fabricating the write chip, and the fabricating of the write chip 212 includes fabricating a mini closure 282 on a surface of the write chip 212 to tune a distance between the array of write transducers 216 and the array of read transducers 224. The technical benefits include a short closure on one of the modules of the tape head (before assembly) for tuning the distance between tape writers and tape readers, and providing enhanced wear robustness (by reducing the span of tape not supported by a hard ceramic).

In one aspect, a tape head 250 comprises a write chip 212, the write chip 212 comprising an array of write transducers 216 and writer bond pads 236, and comprising a write notch 228; and a read chip 220, the read chip 220 comprising an array of read transducers 224 and reader bond pads 240, and comprising a read notch 232; wherein the read chip 220 and the write chip 212 are secured together such that a distance between the write transducer array 216 and the read transducer array 224 is less than 100 microns, an orientation of the write notch 228 exposes the reader bond pads 240, and an orientation of the read notch 232 exposes the writer bond pads 236. The technical benefits include a tape writer with a width comparable to the target track pitch and providing an ˜10% capacity gain in comparison to conventional tape writer configurations.

In example embodiments, a plurality of signal wires fan out from the array of write transducers 216 to the writer bond pads 236 toward one end of the write chip 212. The technical benefits include providing access to the writer bond pads 236 while providing a tape writer with a width comparable to the target track pitch and an ˜10% capacity gain in comparison to conventional tape writer configurations.

In example embodiments, a plurality of signal wires fan out from the array of read transducers 224 to the reader bond pads 240 toward one end of the read chip 220. The technical benefits include providing access to the reader bond pads 240 while providing a tape writer with a width comparable to the target track pitch and an ˜10% capacity gain in comparison to conventional tape writer configurations.

In example embodiments, a shield 286, 290 resides between the write chip 212 and the read chip 220. The technical benefits include reducing magnetic and or electrical cross talk between the write transducers and the read transducers.

In example embodiments, the shield 286, 290 includes at least one of a magnetic shield and an electrical shield. The technical benefits include reducing magnetic and or electrical cross talk, as the case may be, between the write transducers and the read transducers.

In example embodiments, a mini closure 282 resides between the write chip 212 and the read chip 220. The technical benefits include a short closure on one of the modules of the tape head (before assembly) for tuning the distance between tape writers and tape readers, and providing enhanced wear robustness (by reducing the span of tape not supported by a hard ceramic).

In example embodiments, one or more servo transducers 294 are configured to determine an alignment of the tape head 250 with a tape 262. The technical benefits include transducers for aligning the tape head 250 with a tape 262.

In one aspect, a tape drive comprises a tape drive electronics and mechanics module (e.g., one or more as needed of an actuator 278; a control system 278; a servo channel 278; reel-to-reel motors 278; read and write circuitry 278); a write chip 212 coupled to the tape drive electronics and mechanics module, the write chip 212 comprising an array of write transducers 216 and writer bond pads 236, and comprising a write notch 228; and a read chip 220 coupled to the tape drive electronics and mechanics module, the read chip 220 comprising an array of read transducers 224 and reader bond pads 240, and comprising a read notch 232; wherein the read chip 220 and the write chip 212 are secured together such that a distance between the write transducer array 216 and the read transducer array 224 is less than 100 microns, an orientation of the write notch 228 exposes the reader bond pads 240, and an orientation of the read notch 232 exposes the writer bond pads 236. The technical benefits include a tape writer with a width comparable to the target track pitch and providing an ˜10% capacity gain in comparison to conventional tape writer configurations.

In one aspect, a method comprises writing data on a tape 262 using a write chip 212, the write chip 212 comprising an array of write transducers 216 and writer bond pads 236, and comprising a write notch 228; and reading the data on the tape 262 using a read chip 220, the read chip 220 comprising an array of read transducers 224 and reader bond pads 240, and comprising a read notch 232; wherein the read chip 220 and the write chip 212 are secured together such that a distance between the write transducer array 216 and the read transducer array 224 is less than 100 microns. The technical benefits include an ˜10% capacity gain in comparison to conventional tape writer configurations.

In one aspect, a computer program product, comprises one or more tangible computer-readable storage media and program instructions stored on at least one of the one or more tangible computer-readable storage media, the program instructions executable by a processor, the program instructions comprising writing data on a tape 262 using a write chip 212, the write chip 212 comprising an array of write transducers 216 and writer bond pads 236, and comprising a write notch 228; and reading the data on the tape 262 using a read chip 220, the read chip 220 comprising an array of read transducers 224 and reader bond pads 240, and comprising a read notch 232; wherein the read chip 220 and the write chip 212 are secured together such that a distance between the write transducer array 216 and the read transducer array 224 is less than 100 microns. The technical benefits include a tape writer with a width comparable to the target track pitch and providing an ˜10% capacity gain in comparison to conventional tape writer configurations.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a tape writer with a width comparable to the target track pitch and providing an ˜10% capacity gain in comparison to conventional tape writer configurations;
separate ground planes for tape writers, tape readers and their associated wiring, and thus a reduction in crosstalk compared to conventional methods of fabricating tape writers and tape readers on the same wafer;
tape writer and/or reader chips that include magnetic and/or electrical shielding layers above the wiring layer of the transducers; and
a short closure on one of the modules of the tape head (before assembly) for tuning the distance between tape writers and tape readers, and providing enhanced wear robustness (by reducing the span of tape not supported by a hard ceramic).

Generally, techniques are provided for tape drive heads configured to mitigate TDS using skew based compensation. Read while write verification using conventional tape head designs in combination with skew-based TDS compensation requires the use of a wide writer (approximately 10 micrometers (microns)) which results in an approximately 10% reduction in capacity due to the 10 microns width of the last unshingled track written in each sub-databand (shingling refers to partially overlapping adjacent tracks; unshingled tracks are tracks that are not overlapped). In general, the width of the writer required for read while write verification depends on: the required skew range, and the distance between the tape writers and readers (conventionally ˜900 microns). Generally, one or more embodiments provide an exemplary two-module head (including both write and read transducers) and a method of fabricating and assembling the two-module tape head with an arbitrarily small distance between the writers and readers (10's of um), enabling the use of a tape writer with a width comparable to the target track pitch and providing an ˜10% capacity gain in comparison to conventional configurations.

Compared to methods of fabricating tape writers and readers on the same wafer, one or more exemplary embodiments provide separate ground planes for tape writers, readers, and their associated wiring, and thus reduce crosstalk. The writer and/or reader chips can include magnetic and/or electrical shielding layers; for example, above the wiring layer of the write and/or read transducers. One or more exemplary embodiments also enable the inclusion of a very short closure (a “mini” closure; in the range of 5 to 95 μm) on one of the modules of the tape head (before assembly) to tune the distance between the tape writers and readers, and provide enhanced wear robustness (by reducing the span of tape not supported by a hard ceramic). In example embodiments, the mini closure is made from a similar ceramic material to the chip substrate (such as Al2O3—TiC).

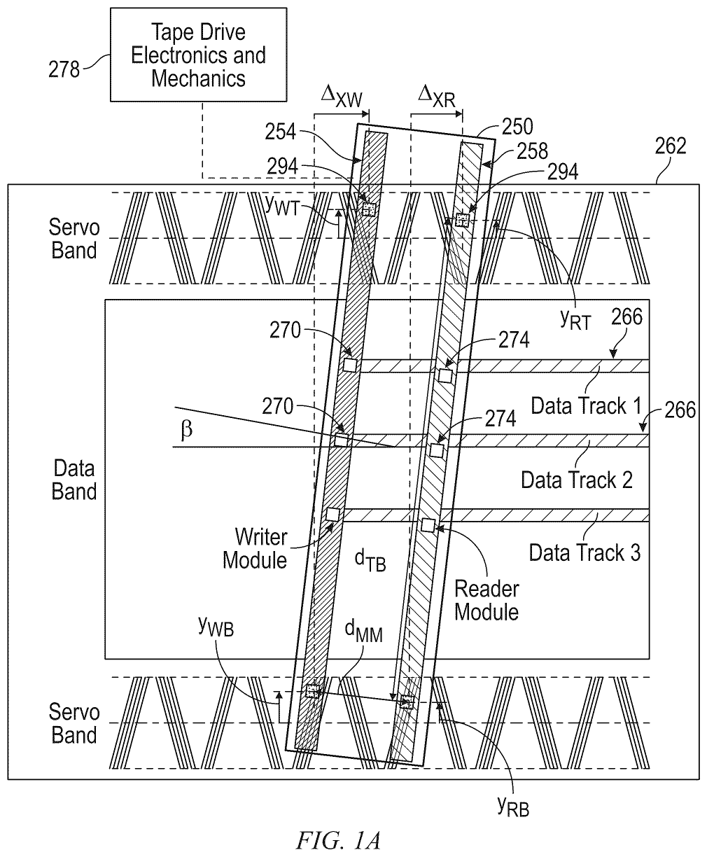

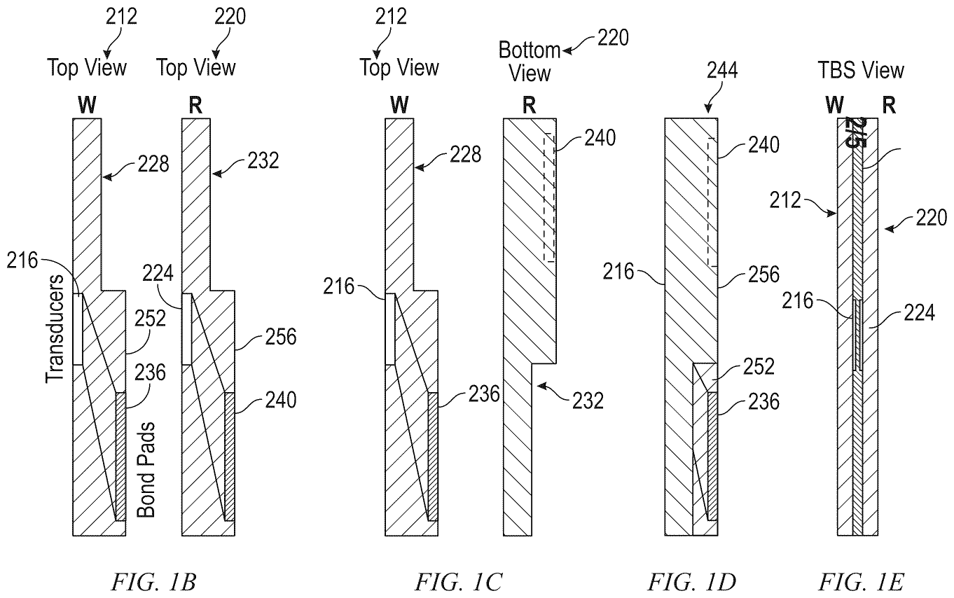

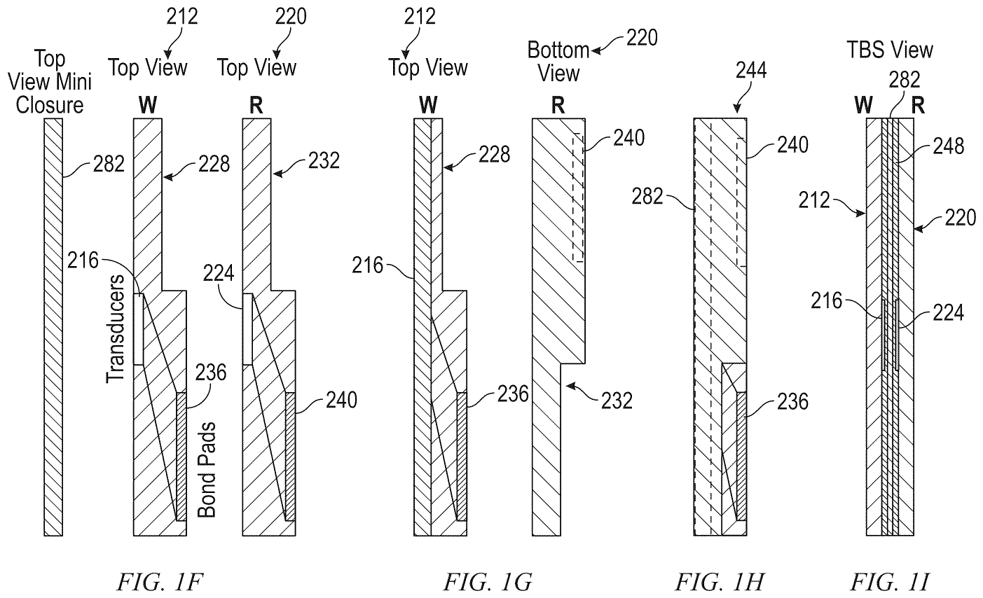

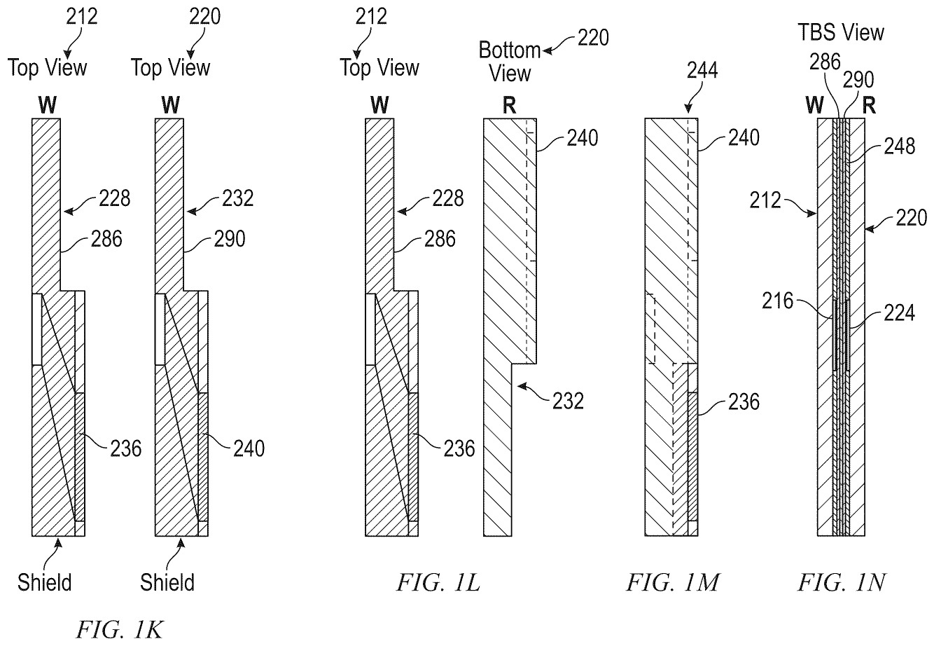

FIG. 1A illustrates a high-level view of a conventional tape head 250 while writing and verifying data. The tape head 250 includes a write module 254 and a read module 258. As a tape 262 passes by the tape head 250, the write transducers 270 of the write module 254 write data on tracks 266 and the read transducers 274 of the read module 258 read the data on the tracks 266 to verify that the data was written correctly. As the tape 262 wanders up and down in the tape path, tape drive electronics and mechanics 278, including a control system, an actuator coupled to the tape head 250, a servo channel, reel-to-reel motors and the like, move the tape head 250 up and down to keep the write transducers 270 of the write module 254 in the correct location in relation to the tracks 266; however, the angle of the tape 262 relative to the tape head 250 can change, creating tape skew, resulting in a potential misalignment of the read transducers 274 of in the reader module 258 with the tracks 266. In one example embodiment, since the tape 262 can expand and shrink over time, an active TDS compensation scheme is utilized to tilt the tape head 250 and realign the write module 254 and the read module 258 with the spacing (pitch) of the desired/target track locations. Once again, if the tilt of the tape head 250 is too large (where β is the angle of the tape head 250 relative to the tape 262), the read transducers 274 on the reader module 258 will not align with the tracks 266.

FIG. 1B illustrates a top view of a write chip 212 and a read chip 220 of a two-module head (write and read) for a tape drive, in accordance with an example embodiment. As illustrated in FIG. 1B, signal wires of the write transducer array 216 fan out to bond pads 236 located at the top of the write chip 212, and signal wires of the read transducer array 224 fan out to bond pads 240 located at the top of read chip 220. (For illustrative convenience, a single strip is shown for each of the arrays of bond pads 236, 240, it being understood that there are, for example, two bond pads per write transducer 270 and two bond pads per read transducer 274 to form arrays of bond pads 236, 240.) In one example embodiment, the write chip 212 and the read chip 220 are configured with a notch 228, 232 to facilitate securing of the write chip 212 and the read chip 220 while exposing the bond pads 236, 240, as described more fully below. (As used herein, securing may be performed by bonding, gluing and the like.) It is noted that the write transducer array 216 (composed of a plurality of write transducers 270) is configured to simultaneously write a plurality of parallel tracks 266 and the read transducer array 224 (composed of a plurality of read transducers 274) is configured to simultaneously read a plurality of parallel tracks 266 on the tape 262, in a known manner.

FIG. 1C illustrates a top view of the write chip 212 and a bottom view of the read chip 220 of a two-module head of FIG. 1B. As illustrated in FIG. 1C, the read chip 220 of FIG. 1B is shown vertically flipped to reveal the bottom view of the read chip 220. Thus, in the disposition illustrated in FIG. 1C, the signal wires of the write transducer array 216 fan out to the bond pads 236 situated at the lower half of FIG. 1C, and the signal wires of the read transducer array 224 fan out to bond pads 240 situated at the upper half of FIG. 1C (where the bond pads 240 are illustrated with dashed lines in FIG. 1C).

FIG. 1D illustrates a top view of the write chip 212 secured to the read chip 220 of a two-module head 244 for a tape drive, in accordance with an example embodiment (note that elements 212, 220, 224, 228, 232 are not separately labeled in FIG. 1D to avoid clutter but are labeled in other figures). The write chip 212, as oriented in FIG. 1C, is secured to the read chip 220, as oriented in FIG. 1C, to form the two-module head 244. As illustrated in FIG. 1D, the read chip 220 is secured on top of the write chip 212. Thus, the write transducer array 216 is located toward the bottom of the two-module head and the read transducer array 224 is located toward the top of the combined two-module head 244, as oriented in FIG. 1D. Similarly, the bond pads 236 of the write chip 212 are located toward the bottom of the page and the bond pads 240 of the read chip 220 are located toward the top of the page, as oriented in FIG. 1D. The shapes of the write chip 212 and the read chip 220 provide a notch 228, 232 that creates a window for accessing the bonding pads 236, 240 after assembly of the two-module head 244. In example embodiments, the write chip 212 and the read chip 220 have separate substrates 252, 256 and separate ground planes. For example, the write chip 212 has its own substrate 252 which serves as a ground plane for the write chip 212 and the read chip 220 has its own substrate 256 which serves as a ground plane for the read chip 220. In one example embodiment, the write transducer array 216 and the read transducer array 224 are separated by about 10-20 microns after securing.

FIG. 1E illustrates a side view of the tape bearing surface (TBS) of the two-module head 244 of FIG. 1D formed of the write chip 212 secured to the read chip 220, in accordance with an example embodiment. The material 248 between the write chip 212 and the read chip 220 may include bonding (or other securing) material, the mini closure, the magnetic and/or electrical shielding layers, or any combination of the foregoing.

In one example embodiment, a ceramic (e.g. AlTiC═Al2O3—TiC) mini closure 282 is secured to one or both of the write chip 212 and the read chip 220 before assembly such that the mini closure 282 resides between the bonding surfaces of the write chip 212 and the read chip 220. FIG. 1F illustrates a top view of a mini closure 282 prior to securing to the write chip 212 and the read chip 220 of a two-module head (write and read) for a tape drive, in accordance with an example embodiment. (As used herein, a mini closure is a rectangular strip of ceramic material, typically the same material as used for the substrates of the write 212 and read chip 220 (such as Al2O3—TiC), that is secured on top of the write transducer array 216 and/or the read transducer array 224, as illustrated in added FIGS. 1G-1I.) FIG. 1G illustrates a top view of the mini closure 282 after securing to the write chip 212, in accordance with an example embodiment. Note that the bond pads 236 remain exposed to facilitate the connection of wire to the individual bond pads.

FIG. 1H illustrates a top view of the write chip 212 secured to the read chip 220 of a two-module head 244 for a tape drive with the mini closure 282 residing between the write chip 212 and the read chip 220, in accordance with an example embodiment (note that elements 212, 220, 224, 228, 232 are not separately labeled in FIG. 1H to avoid clutter but are labeled in other figures). Note that the bond pads 236, 240 remain exposed to facilitate the connection of wires to the individual bond pads. FIG. 1I illustrates a side view of the tape bearing surface (TBS) of the two-module head 244 of FIG. 1H formed of the write chip 212 secured to the read chip 220 with the mini closure 282 residing between the write chip 212 and the read chip 220, in accordance with an example embodiment. The mini closure enables a precise tuning of the spacing between the write transducer 216 and the read transducer 224 by adjusting the thickness of the mini closure, and improves wear robustness by supporting the tape with a hard ceramic (and by reducing the span of tape not supported by a hard ceramic), thereby reducing wear on, for example, the write transducer array 216 and the read transducer array 224.

In one example embodiment, magnetic and/or electrical shielding layers are deposited on top of one or both of the write chip 212 and the read chip 220 before assembly such that the shielding layer(s) resides between the bonding surfaces of the write chip 212 and the read chip 220. FIG. 1K illustrates a top view of a shielding layer 286 after depositing on the write chip 212 and a shielding layer 290 after depositing on the read chip 220, in accordance with an example embodiment. Note that the bond pads 236, 240 remain exposed to facilitate the connection of wire to the individual bond pads. Note also that a single shielding layer 286, 290 may be deposited on only one of the write chip 212 and the read chip 220. Note that the shielding layer 286, 290 cover the transducer arrays 216, 224 and wiring layers of the corresponding chips 212, 220, but leave the bond pads 236, 240 exposed to facilitate the connection of wire to the individual bond pads. FIG. 1L illustrates a top view of the write chip 212 with the shielding layer 286 and the read chip 220 after vertically flipping, in accordance with an example embodiment.

FIG. 1M illustrates a top view of the write chip 212 secured to the read chip 220 of a two-module head 244 for a tape drive with the shielding layer(s) 286, 290 residing between the write chip 212 and the read chip 220, in accordance with an example embodiment (note that elements 212, 220, 224, 228, 232 are not separately labeled in FIG. 1M to avoid clutter but are labeled in other figures). FIG. 1N illustrates a side view of the tape bearing surface (TBS) of the two-module head 244 of FIG. 1M formed of the write chip 212 secured to the read chip 220 with the shielding layers 286, 290 residing between the write chip 212 and the read chip 220, in accordance with an example embodiment. As noted above, only one of the shielding layer 286 and the shielding layer 290 may be implemented.

In example embodiments, the tape head would first be fabricated as a monolithic, rectangular cross-section beam, and the notches 228, 232 would then be cut away from the beam using a dicing saw.

Generally, control can be carried out with hardware, firmware, and/or software. A digital controller can be implemented in digital circuitry. For example, to implement digital circuitry described herein, computer-aided semiconductor integrated circuit (IC) logic design, simulation, test, layout, and/or manufacture can be employed. The computerized design process can represent functional and/or structural design features in a design structure generated using electronic computer-aided design (ECAD). A suitable hardware-description language (HDL) can be employed. The skilled artisan can synthesize digital logic circuits to carry out desired control and other functionality, using known computer-aided design techniques. Given the teachings and description of the functions herein, known control circuit technologies can be employed; e.g., multicycle or pipelined, hardwired or microprogrammed, using any suitable technology family (e.g., 7 nm CMOS, 5 NM CMOS, and the like). For example, the specified functions can be instantiated in logic circuitry using a known design flow process used for example, in semiconductor IC logic design, simulation, test, layout, and manufacture. Such a known design flow for synthesizing digital circuitry includes processes, machines and/or mechanisms for processing design structures or devices to generate logically or otherwise functionally equivalent representations of design structures and/or devices. The design structures processed can be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array). Design structures can be generated using ECAD. Use can be made of HDL design entities or other data structures conforming to and/or compatible with lower-level HDL design languages such as Verilog and VHDL, and/or higher level design languages such as C or C++.

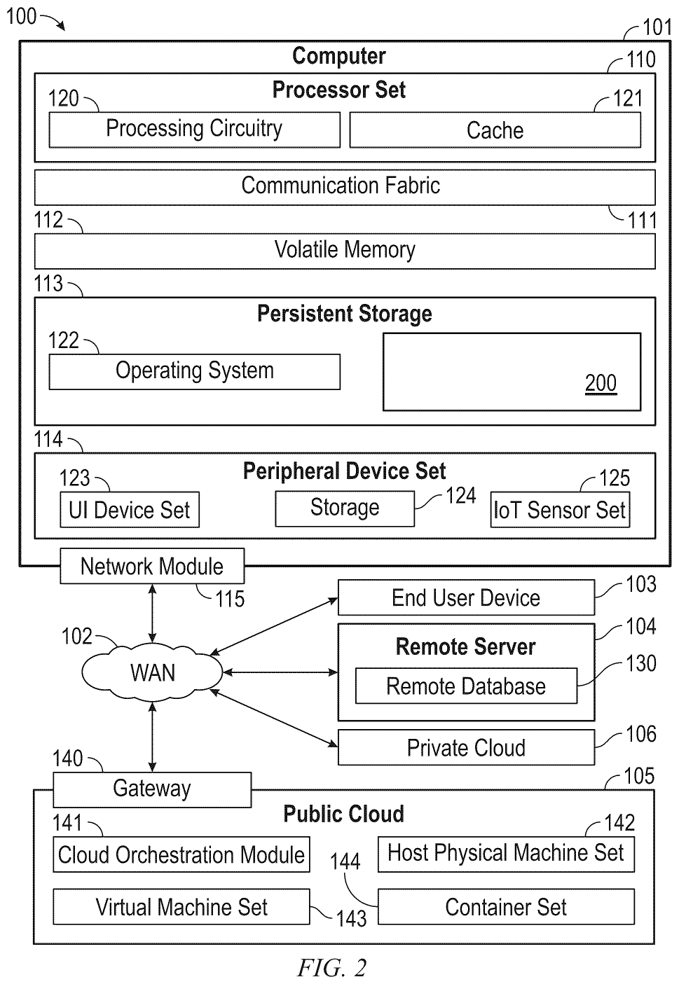

Refer now to FIG. 2. FIG. 2 shows a computer that could use a tape drive according to aspects of the invention, and/or which could be used to carry out the computer-aided semiconductor integrated circuit (IC) logic design, simulation, test, layout, and/or manufacture aspect as discussed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as tape drive controller 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of fabricating a tape head comprising:
obtaining a write chip comprising an array of write transducers and writer bond pads, each write transducer of the array of write transducers connected to a pair of bond pads of the writer bond pads via electrically conducting signal wires, the write chip comprising a write notch;
obtaining a read chip comprising an array of read transducers and reader bond pads, each read transducer of the array of read transducers connected to a pair of bond pads of the reader bond pads via electrically conducting signal wires, the read chip comprising a read notch; and
securing the read chip and the write chip together such that:
a distance between the write transducer array and the read transducer array is less than 100 microns,
an orientation of the write notch exposes the reader bond pads, and
an orientation of the read notch exposes the writer bond pads.

2. The method of claim 1, wherein the obtaining the write chip comprises fabricating the write chip, and the fabricating of the write chip includes forming the plurality of signal wires that fan out from the write transducer array to the writer bond pads toward one end of the write chip.

3. The method of claim 1, wherein the obtaining the read chip comprises fabricating the read chip, and the fabricating of the read chip includes forming the plurality of signal wires that fan out from the read transducer array to the reader bond pads toward one end of the read chip.

4. The method of claim 1, wherein the obtaining the write chip comprises fabricating the write chip, and the fabricating of the write chip includes fabricating a shield above a plane containing the signal wires of the write chip.

5. The method of claim 4, wherein, in the step of fabricating the shield, the shield includes at least one of a magnetic shield and an electrical shield.

6. The method of claim 1, wherein the obtaining the read chip comprises fabricating the read chip, and the fabricating of the read chip includes fabricating a shield above a plane containing the signal wires of the read chip.

7. The method of claim 6, wherein, in the step of fabricating the shield, the shield includes at least one of a magnetic shield and an electrical shield.

8. The method of claim 1, wherein the obtaining the read chip comprises fabricating the read chip, and the fabricating of the read chip includes fabricating a mini closure on a surface of the read chip to tune a distance between the array of read transducers and the array of write transducers.

9. The method of claim 1, wherein the obtaining the write chip comprises fabricating the write chip, and the fabricating of the write chip includes fabricating a mini closure on a surface of the write chip to tune a distance between the array of write transducers and the array of read transducers.

10. A tape head comprising:
a write chip, the write chip comprising an array of write transducers and writer bond pads, and comprising a write notch; and
a read chip, the read chip comprising an array of read transducers and reader bond pads, and comprising a read notch;
wherein the read chip and the write chip are secured together such that:
a distance between the write transducer array and the read transducer array is less than 100 microns,
an orientation of the write notch exposes the reader bond pads, and
an orientation of the read notch exposes the writer bond pads.

11. The tape head of claim 10, further comprising a plurality of signal wires fanning out from the array of write transducers to the writer bond pads toward one end of the write chip.

12. The tape head of claim 10, further comprising a plurality of signal wires fanning out from the array of read transducers to the reader bond pads toward one end of the read chip.

13. The tape head of claim 10, further comprising a shield residing between the write chip and the read chip.

14. The tape head of claim 13, wherein the shield includes at least one of a magnetic shield and an electrical shield.

15. The tape head of claim 10, further comprising a mini closure residing between the write chip and the read chip.

16. The tape head of claim 10, further comprising one or more servo transducers configured to determine an alignment of the tape head with a tape.

17. A tape drive comprising:
a tape drive electronics and mechanics module;
a write chip coupled to the tape drive electronics and mechanics module, the write chip comprising an array of write transducers and writer bond pads, and comprising a write notch; and
a read chip coupled to the tape drive electronics and mechanics module, the read chip comprising an array of read transducers and reader bond pads, and comprising a read notch;
wherein the read chip and the write chip are secured together such that:
a distance between the write transducer array and the read transducer array is less than 100 microns,
an orientation of the write notch exposes the reader bond pads, and
an orientation of the read notch exposes the writer bond pads.

18. The tape drive of claim 17, further comprising a plurality of signal wires fanning out from the array of write transducers to the writer bond pads toward one end of the write chip.

19. The tape drive of claim 17, further comprising a plurality of signal wires fanning out from the array of read transducers to the reader bond pads toward one end of the read chip.

20. The tape drive of claim 17, further comprising a shield residing between the write chip and the read chip.

21. The tape drive of claim 20, wherein the shield includes at least one of a magnetic shield and an electrical shield.

22. The tape drive of claim 17, further comprising a mini closure residing between the write chip and the read chip.

23. The tape drive of claim 17, further comprising one or more servo transducers configured to determine an alignment of the tape head with a tape.

24. A method comprising:
writing data on a tape using a write chip, the write chip comprising an array of write transducers and writer bond pads, and comprising a write notch; and
reading the data on the tape using a read chip, the read chip comprising an array of read transducers and reader bond pads, and comprising a read notch;
wherein the read chip and the write chip are secured together such that a distance between the write transducer array and the read transducer array is less than 100 microns.

25. A computer program product, comprising:
one or more tangible computer-readable storage media and program instructions stored on at least one of the one or more tangible computer-readable storage media, the program instructions executable by a processor, the program instructions comprising:
writing data on a tape using a write chip, the write chip comprising an array of write transducers and writer bond pads, and comprising a write notch; and
reading the data on the tape using a read chip, the read chip comprising an array of read transducers and reader bond pads, and comprising a read notch;
wherein the read chip and the write chip are secured together such that a distance between the write transducer array and the read transducer array is less than 100 microns.
